(19) United States
(12) Patent Application Publication
(10) Pub. No.: US 2026/0194032 A1
(43) Pub. Date: Jul. 9, 2026

(54) ENGINE AIR INTAKE PRESEPARATION USING ELECTROSTATICALLY ACTIVE MATERIALS

(71) Applicant: Parker-Hannifin Corporation, Cleveland, OH (US)

(72) Inventors: Daniel J. Copley, Lawrenceburg, TN (US); Sucharitha Rajendran, Nashua, NH (US)

(73) Assignee: Parker-Hannifin Corporation, Cleveland, OH (US)

(21) Appl. No.: 19/556,481

(22) Filed: Mar. 4, 2026

Related U.S. Application Data
(63) Continuation of application No. PCT/US2024/042214, filed on Aug. 14, 2024.
(60) Provisional application No. 63/537,211, filed on Sep. 8, 2023.
(60) Provisional application No. 63/619,854, filed on Jan. 11, 2024.

(51) Int. Cl. F02M 35/08; F02M 35/02; F02M 35/024

(52) U.S. Cl. CPC F02M 35/086; F02M 35/0202; F02M 35/0217; F02M 35/024

(57) ABSTRACT

An air cleaner apparatus such as a pre-cleaner for an engine with spin tubes is provided with electrostatic material selection to enhance inertial separation. The assembly includes an inertial separator that may be a spin tube or other baffle apparatus. Each inertial separator comprises an air inlet, a clean air outlet, a contaminant outlet, and a baffle arranged to redirect airflow between the air inlet and the clean air outlet. The inertial separator comprises a first electrostatic material arranged to electrostatically urge contaminants toward the contaminant outlet. A second electrostatic material may be used in combination in which one material tends to repel and the other material tends to attract dust particles to enhance inertial separation efficiency.

### CROSS-REFERENCE TO RELATED PATENT APPLICATIONS

This Patent Application is a Continuation of PCT Patent Application No. PCT/US2024/042214, filed Aug. 14, 2024, which is now pending, the entire teachings and disclosure of which are incorporated herein by reference thereto. This Patent Application claims the benefit of U.S. Provisional Patent Application No. 63/619,854, filed Jan. 11, 2024, and U.S. Provisional Patent Application No. 63/537,211, filed Sep. 8, 2023, the entire teachings and disclosure each of which are incorporated herein by reference thereto.

### FIELD OF THE INVENTION

The present invention generally relates to inertial separators and more particularly to inertial separators that may be used in air filtration applications.

### BACKGROUND OF THE INVENTION

Pre-separation of dust prior to entering an air filter system greatly improves the service life of the air filter and helps meet customer capacity targets. Inertial pre-separators have been used in the engine air intake industry for many years to remove dust particles prior to entering an air filter, extending service life and improving system dust load capacity.

Inertial separators are used both in radial seal air filters with tangential inlets and using panels containing a plurality of vaned spin tubes. Parker Rotopamic® Series is one such example as shown for example in Racor® Filter Division Europe Engine Air Filtration Systems brochure, as at https://www.parker.com/content/dam/Parker-com/Literature/Racor-Europe/fdrb371uk.pdf. Another type of inertial separator is shown in Dynavane® Series Inertial Air Filter brochure.

PCT Patent Publication WO2021091880 describes the addition of a constrictor that may be used for improvement of air flow distribution. Much work has been done to optimize the performance of these systems by adjusting the placement of tubes and geometry of inlet vanes, body or vortex finder (see e.g., DE102012020134A1). The performance of such systems using purely inertial, or separation mechanisms is limited and a novel way to further improve performance is needed.

Other inertial separator arrangements having baffles for redirecting air flow to help facilitate particle separation are discussed in various patent publications and literature including KR2018136740A; KR2476524B1; CN112378019A; US20220184433A1; CN105727676B; KR2002079159A; and EEM606 AIR POLLUTION AND ITS CONTROL. Some of these may also employ additional electrostatic devices for removing particulate but often appear to require electrically or mechanically active devices to generate static charge. For example, Korean patent KR 10247524 requires an electrostatic induction roller which is presumptively mechanically driven. Similarly, KR20020079159 appears to discuss use of a charging electrode and collecting electrode. However, such mechanical and electrical activation is not practical in many applications.

### BRIEF SUMMARY OF THE INVENTION

An inertial separator is provided for use in engine air intake applications for the separation of particulates prior to entering an air filter. The inertial pre-separator uses the differing electrostatic properties of plastic materials to improve system efficiency by repelling or attracting charged dust particles as they pass through an air system housing.

One aspect is directed toward an air cleaner apparatus for separating contaminants from an air flow stream, comprising at least one inertial separator. Each inertial separator comprises: (a) an air inlet, (b) a clean air outlet, (c) a contaminant outlet, and (d) baffle arranged to redirect airflow between the air inlet and the clean air outlet. The inertial separator comprises a first electrostatic material arranged to electrostatically urge contaminants toward the contaminant outlet.

Various features may be used with this aspect alone and/or in combination with each other as detailed in any of the following paragraphs.

It is a feature according to many embodiments that the baffle provides a vortex generator creating centrifugal force to contaminants in the air flow stream. In such embodiments, the contaminant outlet may be disposed radially outboard of the air inlet.

Preferably as a further feature, the inertial separator also comprises a second electrostatic material of an opposite charge property of the first electrostatic material.

It is a further feature in relation to the above feature that the first electrostatic material has a positive charge property, and the second electrostatic material has a negative charge property. The first electrostatic material having the positive charge property includes portions disposed radially inside of the contaminant outlet, while the second electrostatic material having the negative charge property includes portions disposed radially outside of the contaminant outlet.

It is a further feature that the first and second electrostatic materials are different plastic materials.

For example, the (a) the first electrostatic material (having a positive charge property) may comprise a polyamide; and (b) the second electrostatic material (having a negative charge property) may comprise: a polyethylene, a polyvinyl chloride a polypropylene, a fluoropolymer, or any combination of two or more of these plastic materials.

Preferably, the second electrostatic material comprises a polyethylene or a polypropylene.

It is a feature that the baffle comprises at least one vane of the first electrostatic material and that is being a plastic material having a positive triboelectric charge property.

It is a feature that each inertial separator can be embodied as a spin tube assembly (also sometimes and interchangeably referred to as “spin tube”). Each spin tube assembly can comprise: (a) a tube body having the air inlet at a first end and a second open end with a flow passage therebetween for communicating the air flow stream; (b) a vortex generator comprising at least one vane providing the baffle imparting a vortex to the air flow stream within the tube body; and (c) a vortex finder extending coaxially relative to the tube body proximate the second open end, with the vortex finder defining an opening to provide the clean air outlet, and wherein a region radially between the vortex finder and the tube body defines the contaminant outlet.

It is a feature that the vortex generator comprises a plastic having a positive triboelectric charge property.

It is a feature that the vortex finder comprises a plastic having a positive triboelectric charge property.

It is a feature that the tube body comprises a plastic having a negative triboelectric charge property.

It is a feature that the vortex generator further comprises a shaft centrally disposed in the tube body concentrically disposed about tube axis, with the at least one vane extending radially outward therefrom in spiral manner, preferably helically.

It is a feature that the air cleaner apparatus may include a single spin tube assembly or a plurality of spin tube assemblies (i.e., “spin tube(s)”) are provided and provide for the at least one inertial separator. The air cleaner apparatus may further comprise an enclosure including: (a) an inlet tube panel defining entrance openings, wherein each spin tube has the tube body thereof mounted to or integral with a different one of the entrance openings; (b) an outlet tube panel in space relation to the inlet tube panel and defining exit openings, wherein each spin tube has the vortex finder thereof mounted to or integral with a different one of the exit openings; (c) a sidewall extending between the inlet tube panel and the outlet tube panel surrounding a contaminant collection region between the inlet tube panel and the outlet tube panel with the spin tubes extending through the contaminant collection region; and (d) an ejector port provided by the enclosure proximate a gravitational bottom of the enclosure for ejecting contaminants separated into the contaminant collection region by the spin tubes.

It is a feature that the inertial separator is a passive cleaner by being without an electrically active device for generating charge and also without a mechanical active device for generating charge.

It is a feature that non-spin tube embodiments are contemplated. In another embodiment, the air inlet is provided by a first elongated slot in an inlet panel that is axially aligned the with contaminant collector having a second elongated slot defining the contaminant outlet. The first elongated slot wider than the second elongated slot with the air flow stream directed axially along an inertial flow passage extending from the first elongated slot toward the second elongated slot. In this embodiment, the baffle comprises first and second sets of spaced part vanes on opposite sides of the inertial flow passage, respectively. The first and sets converge from the air inlet toward the contaminant outlet, with the clean air outlet provided by gaps between vanes. The vanes comprises a plastic material having a positive triboelectric charge property.

In this alternative embodiment, each of the vanes in each set may be aligned with each other in spaced nesting relationship, with each vane having a V-shaped profile with a rounded apex.

In this alternative embodiment, the contaminant collector may comprise a plastic material having a negative triboelectric charge property.

The air cleaner apparatus aspect and/or one or more features above, may be incorporated into an engine air filtration system comprising the air cleaner apparatus. Such engine air filtration system may comprise: (a) an air flow duct from the air cleaner apparatus toward an engine; and (b) a primary air filter cartridge comprising filter media interposed along the air flow duct downstream of the air cleaner apparatus to further clean the air flow stream, wherein the air cleaner apparatus provides a pre-cleaner.

In the above engine air filtration system, the air inlet duct is of a preferably of a material (i.e., of a negative charge property on the triboelectric scale) inducing a positive charge to contaminants int the air flow stream which may strip electrons away from dust particles in the air stream.

In the above engine air filtration system, optionally a secondary air filter comprising filter media along the air flow duct is downstream of the primary air filter.

In the above engine air filtration system, optionally a blower is provided for increasing air flow along the air flow stream.

Another aspect is directed toward a method of separating contaminants from an airstream, comprising: (a) inertially separating contaminants in an air flow stream by inertially directing contaminants toward a contaminant outlet and a cleaner air portion toward a clean air outlet; and (b) simultaneously electrostatically urging contaminants toward the contaminant outlet during said inertially separating.

It is a feature that the method may comprise utilization of different tribolectric charge properties of different plastic materials to electrostatically urge contaminants toward the contaminant outlet.

It is a feature that the method may further comprise creating a vortex with a vortex generator to centrifugally urge contaminants radially outward away from an axis, with the contaminant outlet is radially outboard of the clean air outlet.

In the above feature, preferably, the vortex generator has a positive triboelectric charge property and a wall portion surrounding the contaminant outlet has a negative triboelectric charge property.

It is a feature that the method may further comprise filtering air flow exiting the clean air outlet with at least one barrier filter media to remove contaminants not separated into the contaminant outlet to generate a cleaned airflow stream and directing the cleaned air flow stream toward an engine for combustion with a fuel.

It is a feature that the method may accomplish electrostatically urging in a passive manner without an electrically active device for generating charge and without a mechanical active device for generating charge.

Another inventive aspect is directed toward a spin tube assembly (a.k.a. “spin tube”) comprising: (a) a tube body having the air inlet at first end and a second open end with a flow passage therebetween for communicating the air flow stream; (b) a vortex generator comprising at least one vane providing the baffle imparting a vortex to the air flow stream within the tube body; (c) a vortex finder extending coaxially relative to the tube body proximate the second open end, the vortex finder defining an opening to provide a clean air outlet, and wherein a region radially between the vortex finder and the tube body defines a contaminant outlet; and (d) wherein the tube body and the vortex generator comprise different plastic materials with different triboelectric charge properties.

It is a feature that the vortex generator comprises a first plastic material having a positive triboelectric charge property, and wherein the tube body comprises a second plastic material having a negative triboelectric charge property.

It is a feature that at least the vortex finder comprises a positive triboelectric charge property.

The vortex generator may further comprise a shaft centrally disposed in the tube body with the at least one vane extending radially outward therefrom in spiral manner which preferably is helical.

In such spin tube assembly, different plastic materials may be used and may comprise: (a) a first electrostatic material comprising a polyamide; and (b) a second electrostatic material comprising: a polyethylene, a polyvinyl chloride a polypropylene, a fluoropolymer, or any combination of two or more of these plastic materials.

Preferably, the different plastic materials comprise a polyamide, and either a polypropylene or a polyethylene.

The spin tube assembly may be incorporated into a precleaner comprising a plurality of spin tubes (i.e., each spin tube being one spin tube assembly). The precleaner comprises: an enclosure including: (a) an inlet tube panel defining entrance openings, wherein each spin tube has the tube body thereof mounted to or integral with a different one of the entrance openings; (b) an outlet tube panel in space relation to the inlet tube panel and defining exit openings, wherein each spin tube has the vortex finder thereof mounted to or integral with a different one of the exit openings; (c) a sidewall extending between the inlet tube panel and the outlet tube panel surrounding a contaminant collection region between the inlet tube panel and the outlet tube panel with the spin tubes extending through the contaminant collection region; and (d) an ejector port provided by the enclosure proximate a gravitational bottom of the enclosure for ejecting contaminants separated into the contaminant collection region by the spin tubes.

Another inventive aspect is directed toward a preseparator for removing particles from an air flow within an engine air intake system. One or more of the above or below features may be used in combination with this aspect.

The preseparator comprises: an air inlet duct; a dust collection chamber with internal walls and dust ejection opening, downstream of the air inlet duct; at least one spin tube supported within the dust collection chamber, the at least one spin tube including an outer wall and internal helical vanes, and being located downstream of the air inlet duct to receive air flow from the air inlet duct; a spin tube vortex finder downstream of the at least one spin tube to receive air flow from the at least one spin tube; and an air outlet duct downstream of the spin tube vortex finder to receive air flow from the spin tube vortex finder. Further, the air inlet duct is of a material having either positive or negative electrostatic charge, such that positive or negative charge is induced in particles in the air flow passing through the inlet duct. And the spin tube outer wall is of a material having the same electrostatic charge as the air inlet duct. Additionally, at least one of the internal helical vanes, spin tube vortex finder and internal walls of the dust collection chamber is formed of a material having an opposite electrostatic charge as the air inlet duct, such that particles are attracted to the spin tube outer wall, and repelled from the at least one of the internal helical vanes and spin tube vortex finder when passing through the preseparator.

It is a feature for any of the aspects that the air inlet duct is preferably of a material having a negative electrostatic charge inducing a positive charge (i.e., for dust particles).

It is a feature for any of the aspects that the material of the internal helical vanes, spin tube vortex finder and walls of the dust collection chamber is one of a polyamide or polypropylene.

It is a feature for any of the aspects the material of the spin tube outer wall is the other of the polyamide or polypropylene.

In most applications and environments, the anticipated dust particles primarily will have a positive charge property such that vanes and/or spin tube vortex finder are of a positive charge property (e.g., polyamide); and the air inlet duct and/or spin tube outer wall is of a negative charge property (e.g., preferably polypropylene, polyethylene, and/or other such negative charge plastic material).

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric cross-section of an inertial separator in the form of a pre-cleaner assembly incorporated into an engine air intake system, parts of which being shown schematically, in accordance with a first embodiment of the present invention;

FIG. 2 is a cross-section isometric view of the spin tube assembly shown in FIG. 1, with break lines showing the spin tube wall preferably integral with the inlet tube panel, and with break lines show the vortex finder preferably integral with the outlet tube panel;

FIG. 3 is an exploded isometric assembly view of the spin tube assembly shown in FIG. 2;

FIG. 4 is a chart detailing different positive/negative electrostatic/triboelectric charge properties of different materials evidencing the properties for different plastics that may be utilized in the precleaner assembly and for typical contaminate particulates in an airflow stream (e.g., dust may contain salt and silica akin to glass).

FIG. 5 is a partly schematic cross section of an inertial separator according to another embodiment of the present invention;

FIG. 6 is a partly exploded, isometric cut-away view of a separator assembly incorporating the inertial separator of FIG. 5;

FIGS. 7 and 8 and partly schematic side/end view s of the separator assembly of FIG. 6; and

FIG. 9 is an isometric cross-section of an inertial separator in the form of a pre-cleaner assembly incorporated into an engine air intake system similar to that of FIG. 1, however this embodiment shown with multiple spin tube assemblies according to a further embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

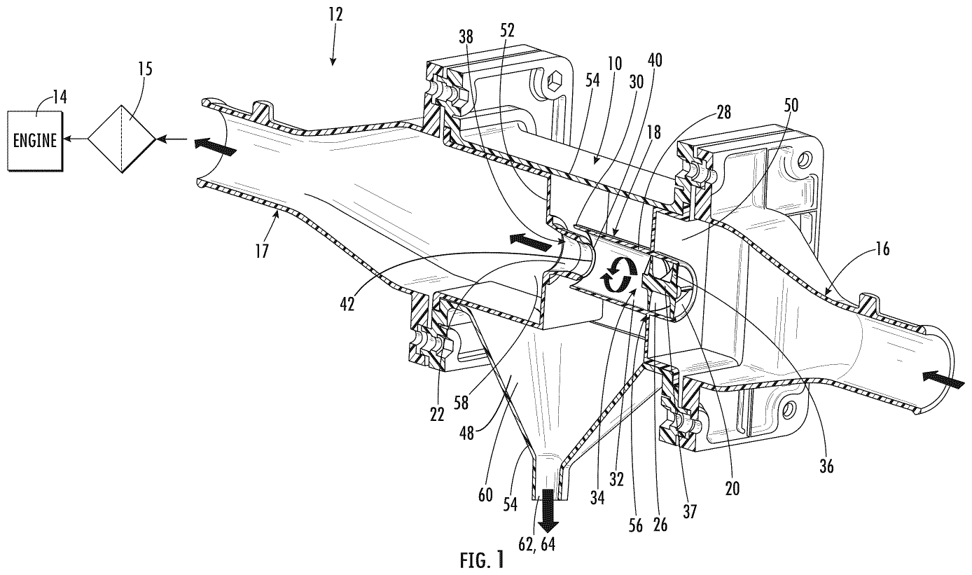

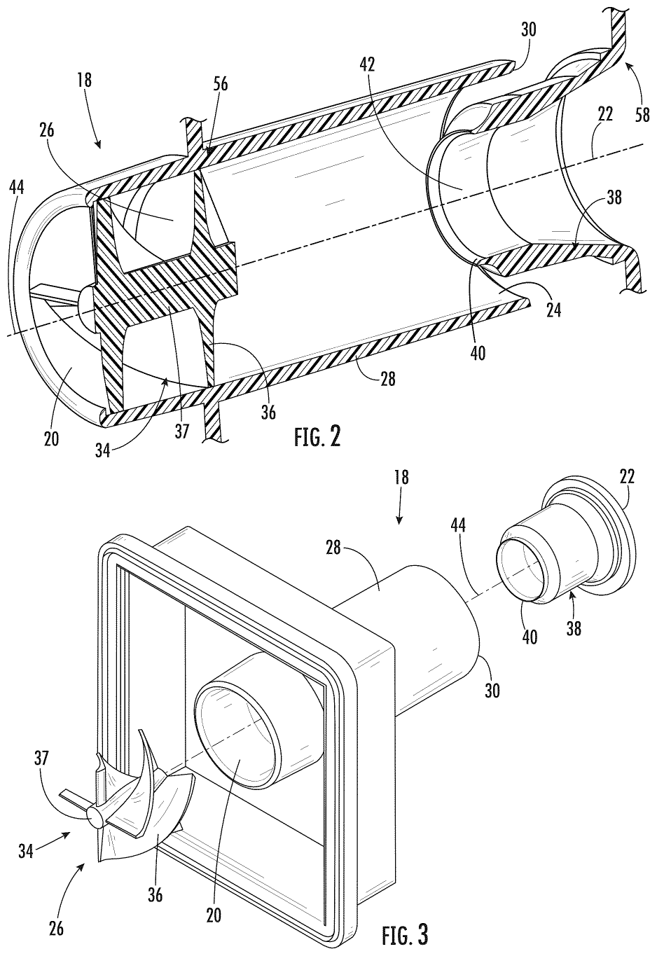

Referring to FIGS. 1-3, an air cleaner apparatus is illustrated as a pre-cleaner assembly 10 in an air intake system 12 for an engine 14 such as an internal combustion engine. The pre-cleaner assembly 10 is arranged to separate contaminants from an air flow stream entering through an air intake port or the air inlet duct 18 and is thus in fluid series between the air inlet duct 18 and the engine 14.

In such an air intake system 12 for an engine 14, typically a further and final finish particular separation is conducted by an air filter 15. The air filter 15 is arranged in fluid series between the pre-cleaner assembly 10 and the engine 14.

The pre-cleaner assembly 10 is therefore arranged to do an initial stage of separation with removal of contaminants and especially larger contaminants. The air filter 15 (e.g., containing a sheet of filter media fibers that may be in the form of a pleated of fluted filter media pack) is arranged to cause all of the air flow to pass therethrough before reaching the engine and completes at least one second stage of contaminant separation. The pre-cleaner assembly 10 therefore enhances the service life of the air filter 15 by extending its service life by separating particles that would otherwise prematurely loading and start to clog the air filter creating undesirable pressure drop.

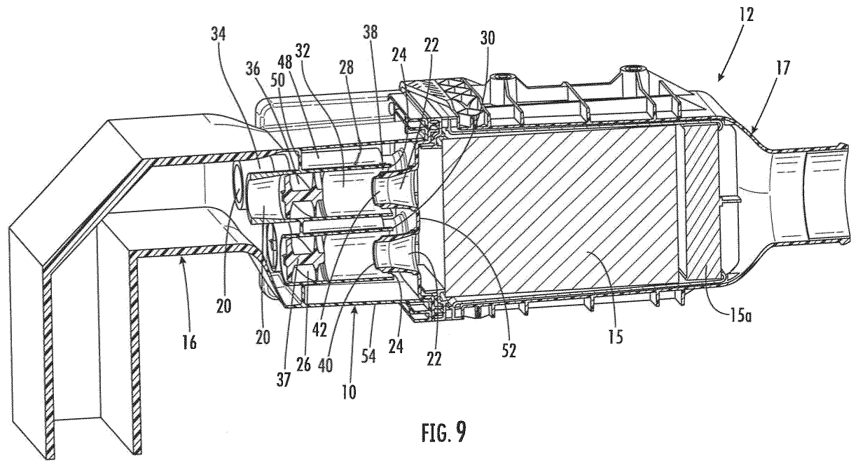

Optionally, a second air filter (not shown in FIG. 1 but a secondary filter 15a is shown in FIG. 9) may be provided downstream of air filter 15 as a “secondary filter”.

The precleaner assembly 10 includes at least one inertial separator. The at least one inertial separator is illustrated as a single spin tube assembly 18 in FIG. 1 and is illustrated as multiple spin tube assemblies 18 such as shown in FIG. 9. These embodiments are similar other than the number of spin tube assemblies 18 such that like reference numbers are used.

The construction of each spin tube assembly such as shown in FIG. 9 can generally be in accordance with PCT Patent Publication WO2021091880, entitled Air flow distribution arrangements in pre-cleaner systems, the entire disclosure of which is thereby incorporated by reference. The construction may optionally include constrictors as disclosed in WO2021091880. In accordance with the present invention, embodiments herein additionally employ material selection that aid inertial separation by electrostatically urging contaminants in a manner to enhance contaminant separation from the air flow stream. For example, a specific selected plastic material is employed to enhance separation and even more preferably different plastic materials of different triboelectric properties may be applied to different components as discussed herein.

Before turning to material selection, attention will first be had to structural features. Each inertial separator (e.g., spin tube assembly 18) comprises: (a) an air inlet 20, (b) a clean air outlet 22, (c) a contaminant outlet 24, and (d) baffle 26 arranged to redirect airflow between the air inlet 20 and the clean air outlet 22. In accordance with inventive aspect, the inertial separator(s) (e.g., spin tube assembly 18) comprises a first electrostatic material arranged to electrostatically urge contaminants toward the contaminant outlet 24.

In this type of inertial separator shown in FIG. 1-3, the baffle 26 provides for a vortex generator 34 which creates centrifugal force to the contaminants (e.g., dust particles, which most typically have a propensity to be positively charged) in the air flow stream. The vortex generator centrifugally urges contaminants radially outward to direct contaminants toward the contaminant outlet 24, which is disposed radially outboard of the air inlet 20.

Each spin tube assembly 18, comprises: a tube body 28, the vortex generator 34, and a vortex finder 38. The tube body 28 has the air inlet 20 at a first end and a second open end 30 with a flow passage 32 therebetween for communicating the air flow stream. The vortex generator 34 is positioned and secured (e.g., glued, otherwise bonded, press-fit, and/or heat welded such as spin welding of the tube body inlet end) within the flow passage 32 of the tube body 28.

Within the flow passage 32, the vortex generator 34 comprises at least one vane 36 (providing the baffle 26) imparting a vortex to the air flow stream along the flow passage 32 within the tube body 28. The vortex finder 38 and extends coaxially relative to the tube body 28 proximate the second open end 30. For example, the vortex finder 38 may be in the form of an annular sleeve having a ring shaped knife edge 40 coaxially received into the second open end 30. The vortex finder defines an opening 42 (e.g., may be defined by the knife edge 40) to provide the clean air outlet 22. With this arrangement, a region radially between the vortex finder 38 and the tube body 28 defines the contaminant outlet 24.

With this arrangement, the precleaner assembly 10 can inertially separate contaminants in the air flow stream, by inertially directing contaminants toward the contaminant outlet 22 heavier contaminant particles are centrifugally forced radially outwardly where the contaminant outlet 24 resides, and thereby leaving a cleaner air portion directed toward a clean air outlet (e.g., the central opening 42 within the knife edge 40).

For arranging either a single spin tube assembly 18 or a plurality of spin tube assemblies, the precleaner assembly 10 further comprises an enclosure such as dust collection chamber/bin 48 through which each spin tube assembly 18 passes.

The dust collection chamber/bin 48 is provided by an inlet tube panel 50, an outlet tube panel 52, a sidewall 54. The inlet tube panel 50 defines entrance openings 56, with each spin tube assembly 18 having the tube body 28 thereof mounted to or integral with a different one of the entrance openings 56. The outlet tube panel 50 is in spaced relation (typically parallel spaced relation) to the inlet tube panel 50 and defines exit openings 58. Each spin tube assembly 18 has the vortex finder 38 thereof mounted to or integral with a different one of the exit openings 58. The sidewall 54 extends between the inlet tube panel 50 and the outlet tube panel 52 and surrounds a contaminant collection region 60 between the inlet tube panel 50 and the outlet tube panel 52 with the spin tube assemblies 18 extending through the contaminant collection region 60.

Preferably, as shown in the embodiments of both FIGS. 1-3 and 9, the tube body(s) 28 are integral with a different one of the entrance openings 56, in that for example the tube body(s) 28 can be integrally molded and unitary with the inlet tube panel 50 as a single piece component part. However, it is also contemplated that the tube body(s) 28 could be separate tube members mounted into holes of a separately formed tube panel 50.

Similarly, it is preferred as shown in the embodiments of both FIGS. 1-3 and 9, the vortex finder(s) 38 are integral with a different one of the exit openings 58 in that for example the vortex finder(s) 38 can be integrally molded and unitary with the outlet tube panel 52 as a single piece component part. However, it is also contemplated that the tube vortex finder(s) 38 could be separate tube members mounted into holes of a separately formed tube panel 52.

To facilitate removal of inertially separated dust from the precleaner assembly 10, the precleaner assembly further includes an ejector port 62. The ejector port 62 is provided by one of the enclosures walls typically proximate the gravitation bottom to use gravity to help expel contaminants from the precleaner assembly 10.

In this case, the ejector portion 62 is provided by the sidewall 54 proximate the gravitational bottom 64 (e.g., at the gravitational bottom 64 as shown) for ejecting contaminants have been separated into the contaminant collection region by the spin tube assemblies 18.

With the embodiments herein, material selection is used to enhance inertial separation. In particular, the inertial separator comprises a first electrostatic material arranged to electrostatically urge contaminants toward the contaminant outlet. This achieves a method that simultaneously electrostatically urges contaminants toward the contaminant outlet 24 during inertially separating by an inertial separator.

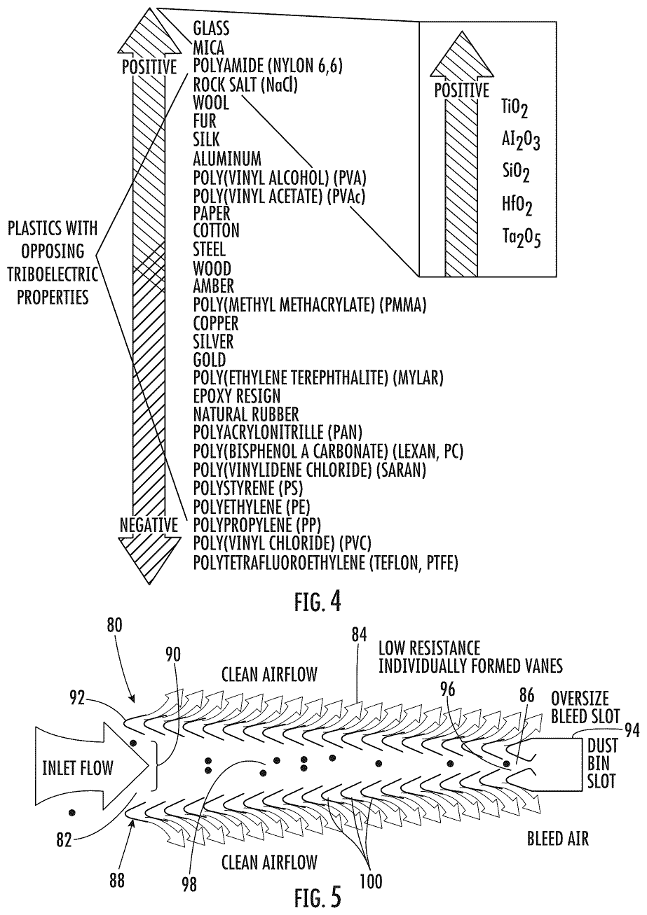

Preferably, the inertial separator comprises a second electrostatic material of an opposite charge of the first electrostatic material. For example, the first electrostatic material having a positive charge property and the second electrostatic material having a negative charge property. For example, the schematic chart of FIG. 4 demonstrates materials that are of opposite triboelectric properties of increasing magnitude toward either positive charge properties or negative charge properties away from relatively neutral materials (i.e., steel, wood, amber as shown in the chart). Embodiments disclosed herein utilize different triboelectric properties of different materials (and preferably plastic materials) to electrostatically urge contaminants toward the contaminant outlet.

While other materials such as shown in the chart or comparable to those shown in the chart may be used, in many air filtration applications, plastic material is optimal and in particular moldable plastic material. Therefore, preferably the first and second electrostatic materials comprise different plastic materials.

Considering practicalities for precleaner constructions, and while other materials such as those on the chart or akin to those are the chart can be selected, preferably: (a) the first electrostatic material comprises a polyamide; and (b) the second electrostatic material comprises: a polyethylene, a polyvinyl chloride a polypropylene, a fluoropolymer, or any combination of two or more of these plastic materials.

Preferably, the second electrostatic material comprises a polyethylene or a polypropylene.

The arrangement of materials in the precleaner assembly 10 depends upon the anticipated environment to be experienced. The arrangement can be set to anticipate that the contaminants will primarily be either of negative charge property or a positive charge property.

For most typical air filtration environments such as for many internal combustion applications/environments, it is anticipated that that dust particles primarily comprise materials of positive charge property according to the chart of FIG. 4. For example, many of the different potential particulate contaminant materials contain silica (akin to glass), salts and/or various other earth materials of positive charge properties. For such application for dust particles that are primarily of positive charge property: (a) the first electrostatic material having the positive charge property (e.g., comprising a polyamide) includes portions disposed radially inside of the contaminant outlet 24: and (b) the second electrostatic material having the negative charge property includes portions disposed radially outside of the contaminant outlet 24, and optionally the second electrostatic material having the negative charge property is used in upstream locations such as incorporated into the components of the air inlet duct 16.

For example, in FIGS. 1-3 and 9, the first electrostatic material having a positive triboelectric charge property (preferably a plastic material such as a polyamide) is used for the least one vane 36 and its vane support shaft 37, and also preferably the vortex finder 38. In this manner, the vane 36 (and/or its support shaft 37) and/or vortex finder 38 are able to repel the positive charge property contaminants away from the clean air outlet 22 and toward the containment outlet 24.

For example, in FIGS. 1-3 and 9, the second electrostatic material having a negative triboelectric charge property (preferably a plastic material such as polyethylene, a polyvinyl chloride, a polypropylene, and/or a fluoropolymer) is used for at least the outer wall of the spin tube assemblies provided by the tube body 28, and preferably also for the air inlet duct 16.

The first electrostatic material having a positive triboelectric charge property may also optionally be used for the walls of a dust collection enclosure/bin 48 as it is likewise advantageous for the walls of the dust collection chamber/bin 48 surrounding the spin tube assemblies 18 to repel dust particles in order to assist the ejection of dust and prevent buildup or re-entrainment of contaminants.

For example, as shown, preferably at least the outlet panel 52 and the sidewall 54 is of the first electrostatic material having a positive triboelectric charge property. In contrast, the inlet panel 50 may be a different material such as the negative charge property material as shown in FIGS. 1-3 and 9 (optionally, the inlet panel 50 could also be of a positive charge). For example, in FIG. 9, the inlet tube panel 50 is integrated with the air inlet duct 16 and may be of the second electrostatic material having a negative triboelectric charge property. Furthermore, the inlet tube panel 50 is integrally molded with the tube body(s) 28 and thereby has the same negative material charge properties.

For most embodiments and operating environments, the precleaner assembly 19 is designed such that the first electrostatic material has the positive triboelectric charge property and the second electrostatic material has the negative triboelectric charge property However, in another embodiment, the first electrostatic material may have the negative triboelectric charge property and the second electrostatic material having the positive triboelectric charge property. However, this alternative embodiment would be contemplated for situations where the dust particles are primarily negatively charged (e.g., if trying to filter microplastics other than polyamides from an air flow stream or other such similar situations involving anticipated negative charge property contaminants).

Another advantage of the embodiments of the air intake system 12 and pre-cleaner assembly 10 of FIGS. 1-3 and 9 is that the inertial separator is a passive cleaner by being without an electrically active device for generating charge and without a mechanical active device for generating charge.

In particular for an engine application, no electrical charge generator is utilized in the air intake system 12 and pre-cleaner assembly 10 of FIGS. 1-3 and 9, and instead the naturally occurring positive charge properties of dust occurring in environment is utilized in combination with plastic material selection in the pre-cleaner assembly.

Accordingly, as apparent from FIGS. 1-3 and 9, the pre-cleaner assembly 10 from the engine air intake system 12 has been illustrated, including an inlet which provides air flow to a panel incorporating a single tube or a plurality of spin tubes (also referred to as spin tube assemblies 18). Air is caused to rotate around the tube axis 44 on passing through helical cyclone vanes 36 while the contaminant particles in the air having momentum proportional to their mass and velocity are moved under inertial forces towards the outer edges of the spin tube wall provided by tube body 28.

The air then passes axially into the central vortex finder 38 tube and becomes separated from a portion of the contaminant mass before passing through a secondary particulate filtering media of air filter 15 and into an outlet duct 17. The separated mass flow is ejected into the dust collection chamber/bin 48 illustrated and is removed under gravity and engine vibration through a dust ejection opening of ejector port 62.

The separation efficiency of the spin tube 18 is defined as the initial mass flow entering at the inlet minus the mass flow remaining at the outlet divided by the original mass flow at the inlet (%). A higher velocity air flow develops higher separation efficiency; but at the same time the flow restriction of the system also increases. The overall restriction of the system cannot exceed acceptable limits defined by the engine manufacturer and therein lies some of the limitations of the prior art.

The subject pre-separator provided by pre-cleaner assembly 10 uses the passive electrostatic properties of different plastic or metal materials to increase the overall efficiency of a spin tube 18 or array of spin tubes 18 without increasing flow restriction. As discussed in relation to FIGS. 1-3 and 9, the inlet duct may be manufactured from a material possessing either positive or negative electrostatic properties in order to potentially induce a charge on dust particles entering the system. The spin tube vanes 36 are produced from a material exhibiting opposite electrostatic properties in order to repel particles. The spin tube wall provided by tube body 28 can similarly be designed to attract particles, while the spin tube vortex finder 38 can be designed to repel particles. It is likewise advantageous for the walls of the dust collection chamber/bin 48 surrounding the spin tube(s) 18 to repel dust particles in order to assist the ejection of dust and prevent buildup or re-entrainment of contaminants.

As shown in FIG. 4, the materials can be chosen to have opposing triboelectric properties, such as polyamide and polypropylene. The materials are preferably chosen to have as large a difference in triboelectric properties as possible, provided the materials are appropriate for the particular application. It is also preferred that each of the spin tube vanes, spin tube vortex finder and dust collection chamber walls have such opposite charge; nevertheless, only one or less than all of such components can have such opposite charge to achieve at least some improvement in separation efficiency.

It will be understood that this disclosure is not limited to the above and many permutations and combinations of component materials exist which exhibit performance improvements to a greater or lesser extent. It is noted that at any point a ground connection can be used to discharge part or all of the system, provided components are isolated with an insulating material such as a seal. A ground should generally be used on the particulate media housing or outlet duct to discharge any charge caused by dust entering the engine intake.

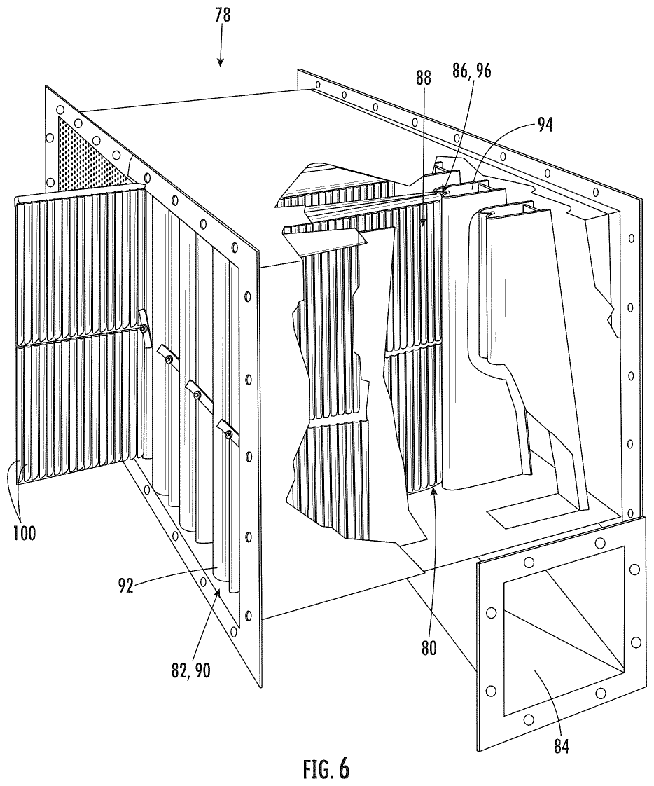

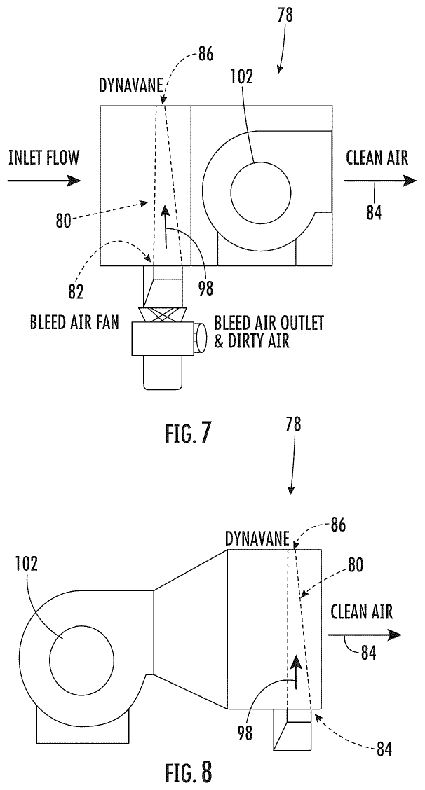

The material selection with different plastic materials having opposite charge properties has been found to result in separation efficiency gains for pre-cleaner assemblies 10 incorporating spin tube assemblies 18 by enhancing inertial separation effects. While significant advantage is realized therefore, material selection is contemplated for other types of inertial separators that do not employ spin tube assemblies. Accordingly, another embodiment of an air cleaner apparatus 78 for separating contaminants from an air flow stream incorporating one or more inertial separators 80 is also shown in FIGS. 5-8 that also uses electrostatic material selection.

In this embodiment, each inertial separator 80 comprises: an air inlet 82, a clean air outlet 84, a contaminant outlet 86, and a baffle 88. The baffle 88 arranged to redirect airflow between the air inlet 82 and the clean air outlet 84 Further, this inertial separator comprises a first electrostatic material arranged to electrostatically urge contaminants toward the contaminant outlet 86. In particular in this embodiment the baffle 88 has a positive charge property (e.g., such as polyamide) to repel particles and the collection bin may be either neutral and/or be of a material with a negative charge property.

In this embodiment, the air inlet 82 is provided by a first elongated slot 90 in an inlet panel 92 that is axially aligned the with contaminant collector 94 having a second elongated slot 96 defining the contaminant outlet 86. The first elongated slot 90 is wider than the second elongated slot 96 with the air flow stream directed axially along an inertial flow passage 98 extending from the first elongated slot 90 toward the second elongated slot 96. The baffle comprises first and second sets of spaced part vanes 100 on opposite sides of the inertial flow passage 98, respectively, the first and sets converging from the air inlet 82 toward the contaminant outlet 86. The clean air outlet 84 is provided by gaps between vanes 100. At least the vanes 100 comprises a plastic material having a positive triboelectric charge property such as polyamide.

Optionally, the contaminant collector 94 comprises a plastic material having a negative triboelectric charge property.

The air cleaner apparatus 78 may be contained in a housing and may optionally include a blower 102 to generate an airstream flow, which may be the case as needed in a non-engine application. Even in the embodiments shown in FIG. 1-3 and 9 a similar blower may be employed (e.g., such as a turbocharger) along the airflow stream.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An air cleaner apparatus for separating contaminants from an air flow stream, comprising: at least one inertial separator, each inertial separator comprising: (a) an air inlet, (b) a clean air outlet, (c) a contaminant outlet, and (d) baffle arranged to redirect airflow between the air inlet and the clean air outlet, and wherein the inertial separator comprises a first electrostatic material arranged to electrostatically urge contaminants toward the contaminant outlet.

2. The air cleaner apparatus of claim 1, wherein the baffle provides a vortex generator creating centrifugal force to contaminants in the air flow stream, and wherein the contaminant outlet is disposed radially outboard of the air inlet.

3. The air cleaner apparatus of claim 2, wherein the inertial separator comprises a second electrostatic material of an opposite charge property of the first electrostatic material, the first electrostatic material having a positive charge property and the second electrostatic material having a negative charge property, and wherein the first electrostatic material having the positive charge property includes portions disposed radially inside of the contaminant outlet, and the second electrostatic material having the negative charge property includes portions disposed radially outside of the contaminant outlet.

4. The air cleaner apparatus of claim 1, wherein the inertial separator comprises a second electrostatic material of an opposite charge property of the first electrostatic material.

5. The air cleaner apparatus of claim 1, wherein the first and second electrostatic materials are different plastic materials.

6. The air cleaner apparatus of claim 5, wherein:
(a) the first electrostatic material comprises a polyamide; and
(b) the second electrostatic material comprises: a polyethylene, a polyvinyl chloride a polypropylene, a fluoropolymer, or any combination of two or more of these plastic materials.

7. The air cleaner apparatus of claim 6, wherein the second electrostatic material comprises a polyethylene or a polypropylene.

8. The air cleaner apparatus of claim 1, wherein the baffle comprises at least one vane of the first electrostatic material being a plastic material having a positive triboelectric charge property.

9. The air cleaner apparatus of claim 1, wherein each inertial separator is a spin tube assembly, comprising:
a tube body having the air inlet at a first end and a second open end with a flow passage therebetween for communicating the air flow stream;
a vortex generator comprising at least one vane providing the baffle imparting a vortex to the air flow stream within the tube body;
a vortex finder extending coaxially relative to the tube body proximate the second open end, the vortex finder defining an opening to provide the clean air outlet, and wherein a region radially between the vortex finder and the tube body defines the contaminant outlet.

10. The air cleaner apparatus of claim 9, wherein the vortex generator comprises a plastic having a positive triboelectric charge property.

11. The air cleaner apparatus of claim 9, wherein the vortex finder comprises a plastic having a positive triboelectric charge property.

12. The air cleaner apparatus of claim 9, wherein the tube body comprises a plastic having a negative triboelectric charge property.

13. The air cleaner apparatus of claim 9, wherein the vortex generator further comprises a shaft centrally disposed in the tube body with the at least one vane extending radially outward therefrom in spiral manner, preferably helically.

14. The air cleaner apparatus of claim 9, wherein a plurality of spin tubes are provided for the at least one inertial separator, further comprising:
an enclosure including:
(a) an inlet tube panel defining entrance openings, wherein each spin tube has the tube body thereof mounted to or integral with a different one of the entrance openings;
(b) an outlet tube panel in space relation to the inlet tube panel and defining exit openings, wherein each spin tube has the vortex finder thereof mounted to or integral with a different one of the exit openings;
(c) a sidewall extending between the inlet tube panel and the outlet tube panel surrounding a contaminant collection region between the inlet tube panel and the outlet tube panel with the spin tubes extending through the contaminant collection region; and
(d) an ejector port provided by the enclosure proximate a gravitational bottom of the enclosure for ejecting contaminants separated into the contaminant collection region by the spin tubes.

15. The air cleaner apparatus of claim 1, wherein the inertial separator is a passive cleaner by being without an electrically active device for generating charge and without a mechanical active device for generating charge.

16. The air cleaner apparatus of claim 1, wherein the air inlet is provided by a first elongated slot in an inlet panel that is axially aligned the with contaminant collector having a second elongated slot defining the contaminant outlet, the first elongated slot wider than the second elongated slot with the air flow stream directed axially along an inertial flow passage extending from the first elongated slot toward the second elongated slot, and wherein the baffle comprises first and second sets of spaced part vanes on opposite sides of the inertial flow passage, respectively, the first and sets converging from the air inlet toward the contaminant outlet, with the clean air outlet provided by gaps between vanes, and wherein the vanes comprises a plastic material having a positive triboelectric charge property.

17. The air cleaner apparatus of claim 16, wherein the contaminant collector comprises a plastic material having a negative triboelectric charge property.

18. An engine air filtration system comprising the air cleaner apparatus of claim 1, and further comprising:
an air flow duct from the air cleaner apparatus toward an engine, wherein the air inlet duct is of a preferably of a material inducing a positive charge to contaminants int the air flow stream; and
a primary air filter cartridge comprising filter media interposed along the air flow duct downstream of the air cleaner apparatus to further clean the air flow stream, wherein the air cleaner apparatus provides a pre-cleaner.

19. A spin tube assembly, comprising:
a tube body having the air inlet at first end and a second open end with a flow passage therebetween for communicating the air flow stream;
a vortex generator comprising at least one vane providing the baffle imparting a vortex to the air flow stream within the tube body;
a vortex finder extending coaxially relative to the tube body proximate the second open end, the vortex finder defining an opening to provide a clean air outlet, and wherein a region radially between the vortex finder and the tube body defines a contaminant outlet; and
wherein the tube body and the vortex generator comprise different plastic materials with different triboelectric charge properties.

20. The spin tube assembly of claim 19, wherein the vortex generator comprises a first plastic material having a positive triboelectric charge property, and wherein the tube body comprises a second plastic material having a negative triboelectric charge property.

21. The spin tube assembly of claim 20, wherein the vortex finder comprises a positive triboelectric charge property.

22. The spin tube assembly of claim 19, wherein the vortex generator further comprises a shaft centrally disposed in the tube body with the at least one vane extending radially outward therefrom in spiral manner, preferably helically.

23. The spin tube assembly of claim 19, wherein the different plastic materials comprise:
(a) a first electrostatic material comprising a polyamide; and
(b) a second electrostatic material comprising: a polyethylene, a polyvinyl chloride a polypropylene, a fluoropolymer, or any combination of two or more of these plastic materials.

24. The spin tube assembly of claim 23, wherein the different plastic materials comprise a polyamide, and either a polypropylene or a polyethylene.

25. A precleaner comprising a plurality of spin tubes, each spin tube comprising the spin tube assembly of claim 19, the precleaner comprising:
an enclosure including:
(a) an inlet tube panel defining entrance openings, wherein each spin tube has the tube body thereof integrally forming or mounted to a different one of the entrance openings;
(b) an outlet tube panel in space relation to the inlet tube panel and defining exit openings, wherein each spin tube has the vortex finder thereof mounted to or integral with a different one of the exit openings;
(c) a sidewall extending between the inlet tube panel and the outlet tube panel surrounding a contaminant collection region between the inlet tube panel and the outlet tube panel with the spin tubes extending through the contaminant collection region; and
(d) an ejector port provided by the enclosure proximate a gravitational bottom of the enclosure for ejecting contaminants separated into the contaminant collection region by the spin tubes.

26. A preseparator for removing particles from an air flow within an engine air intake system, the preseparator comprising:
i. an air inlet duct;
ii. a dust collection chamber with internal walls and dust ejection opening, downstream of the air inlet duct;
iii. at least one spin tube supported within the dust collection chamber, the at least one spin tube including an outer wall and internal helical vanes, and being located downstream of the air inlet duct to receive air flow from the air inlet duct;
iv. a spin tube vortex finder downstream of the at least one spin tube to receive air flow from the at least one spin tube; and
v. an air outlet duct downstream of the spin tube vortex finder to receive air flow from the spin tube vortex finder;
wherein the air inlet duct is of a material having either positive or negative electrostatic charge, such that positive or negative charge is induced in particles in the air flow passing through the inlet duct;
wherein the spin tube outer wall is of a material having the same electrostatic charge as the air inlet duct, and
wherein at least one of the internal helical vanes, spin tube vortex finder and internal walls of the dust collection chamber is formed of a material having an opposite electrostatic charge as the air inlet duct, such that particles are attracted to the spin tube outer wall, and repelled from the at least one of the internal helical vanes and spin tube vortex finder, when passing through the preseparator.

27. The preseparator of claim 26, wherein the air inlet duct is of a material having a negative electrostatic charge inducing a positive charge.

28. The preseparator as in claim 26, wherein the material of the internal helical vanes, spin tube vortex finder and walls of the dust collection chamber is one of a polyamide or polypropylene.

29. The preseparator as in claim 28, wherein the material of the spin tube outer wall is the other of the polyamide or polypropylene.
